(19) United States
(12) Patent Application Publication
(10) Pub. No.: US 2026/0315308 A1
(43) Pub. Date: Oct. 15, 2026

(54) PROXIMITY DETECTION APPARATUS AND METHOD OF USE FOR THE VISUALLY IMPAIRED

(71) Applicant: Dallin Mattson, St. George, UT (US)

(72) Inventor: Dallin Mattson, St. George, UT (US)

(21) Appl. No.: 19/643,388

(22) Filed: Apr. 9, 2026

Related U.S. Application Data
(60) Provisional application No. 63/788,610, filed on Apr. 14, 2025.

(51) Int. Cl. A61H 3/06; A42B 1/242; G01C 21/20; G01S 17/42

(52) U.S. Cl. CPC A61H 3/061; A42B 1/242; G01C 21/20; G01S 17/42; A61H 2003/063; A61H 2201/1607; A61H 2201/165; A61H 2201/5007; A61H 2201/5092

(57) ABSTRACT

A proximity detection apparatus includes a wearable article having one or more proximity sensors and one or more user indicators. The user indicators may be vibrating motors. As an object moves closer to the user, the object is detected by the one or more proximity sensors and a processor of the proximity detection apparatus actuates the one or more user indicators so as to indicate the distance and, in some cases, the direction of the object in relation to the user. The one or more user indicators may vary in intensity so as to indicate the general proximity of the object to the user, with closer distances having increased intensity over farther distances.

### CROSS-REFERENCE TO RELATED APPLICATIONS

This application claims the benefit of U.S. Provisional Application Ser. No. 63/788,610, filed Apr. 14, 2025, which is incorporated herein by reference.

### TECHNICAL FIELD

The present disclosure relates to aides for the visually impaired. More particularly, the present disclosure relates to proximity detection and notification to a visually impaired user.

### BACKGROUND

Visual impairment is prevalent throughout the world and affects individuals across a wide range of ages, environments, and levels of severity. By some estimates, more than one billion people experience some form of vision loss. Such vision loss may range from partial impairment, such as reduced visual acuity or field of view, to severe or near-total blindness. In some cases, individuals may be able to perceive light or general shapes but may be unable to reliably distinguish objects, obstacles, or people in their surroundings. In other cases, individuals with monocular vision—i.e., vision from only one eye—may experience diminished depth perception, reduced peripheral awareness, and difficulty accurately judging distances, among other challenges. As a result, individuals with visual impairments may be more susceptible to inadvertently colliding with people or objects, which can lead to personal injury, property damage, or social discomfort. Indeed, the named inventor has monocular vision and is personally aware of these challenges, leading to the development of this disclosure.

To navigate their surroundings, individuals with visual impairments often rely on a variety of mobility aids and coping strategies. Common approaches include the use of a traditional white cane, guide or service animals, wearable electronic devices that audibly describe the environment, or physical trailing techniques such as using hands to follow walls or nearby surfaces. While these approaches may provide meaningful assistance in many situations, each approach can present certain limitations or inconveniences depending on the context of use.

For example, the use of a white cane typically requires active physical movement and may not detect obstacles located above ground level or outside the immediate sweep path of the cane. Guide animals generally require extensive training, ongoing care, and may not be practical or permitted in all environments. Wearable devices that audibly describe surroundings may draw unwanted attention to the user, interfere with the user's ability to hear ambient sounds, or provide information in a manner that is distracting or undesirable in certain social, professional, or quiet settings. Physical trailing methods may limit the user's freedom of movement and may not be feasible in open or unfamiliar environments.

Accordingly, there remains a need for improved systems and devices that assist visually impaired users in detecting nearby objects and people. In particular, there is a need for an apparatus capable of providing proximity detection in a manner that is discreet, intuitive, and does not require continuous physical motion, service animals, or overt external signaling. It would further be advantageous if such an apparatus could be worn comfortably as part of normal attire, provide real-time feedback regarding the presence and proximity of objects, and operate effectively across a range of environments. The present disclosure is directed to addressing these and other needs.

### SUMMARY OF EXAMPLE EMBODIMENTS

In some embodiments, a proximity detection apparatus may comprise an article of clothing comprising one or more proximity sensors and one or more user indicators. In some embodiments, the user indicators comprise one or more light-emitting diodes (LEDs), one or more vibrating motors, or both. In some embodiments, the user indicators may comprise one or more speakers and/or a wireless transceiver configured to transmit audio to a wireless earbud or hearing aid.

In some methods of use, a user would wear the proximity detection apparatus. In other words, a user may wear the article of clothing (e.g., hat) that comprises the proximity sensors and user indicators. The user indicators may be programmed, via a microcontroller or other processor, to indicate depending on the distance detected by the proximity sensors. For example, as a user approximates an object (e.g., wall), the at least one indicator will indicate to a user that an object is getting closer. In some embodiments, motors may vibrate with varying intensity and location, based upon the location of the detected object.

### BRIEF DESCRIPTION OF THE DRAWINGS

FIG. 1 illustrates a proximity detection apparatus worn by a user and detecting an object at a first distance;

FIG. 2 illustrates a proximity detection apparatus worn by a user and detecting an object at a second, closer distance;

FIG. 3 illustrates a proximity detection apparatus worn by a user and detecting an object at a third, closest distance;

FIG. 4 illustrates a top view of a proximity detection apparatus detecting a first position of an object;

FIG. 5 illustrates a top view of a proximity detection apparatus detecting a second position of an object; and

FIG. 6 illustrates a top view of a proximity detection apparatus detecting a third position of an object.

### DETAILED DESCRIPTION OF EXAMPLE EMBODIMENTS

The following descriptions depict only example embodiments and are not to be considered limiting in scope. Any reference herein to “the invention” is not intended to restrict or limit the invention to exact features or steps of any one or more of the exemplary embodiments disclosed in the present specification. References to “one embodiment,” “an embodiment,” “various embodiments,” and the like, may indicate that the embodiment(s) so described may include a particular feature, structure, or characteristic, but not every embodiment necessarily includes the particular feature, structure, or characteristic. Further, repeated use of the phrase “in one embodiment,” or “in an embodiment,” do not necessarily refer to the same embodiment, although they may.

Reference to the drawings is done throughout the disclosure using various numbers. The numbers used are for the convenience of the drafter only and the absence of numbers in an apparent sequence should not be considered limiting and does not imply that additional parts of that particular embodiment exist. Numbering patterns from one embodiment to the other need not imply that each embodiment has similar parts, although it may.

Accordingly, the particular arrangements disclosed are meant to be illustrative only and not limiting as to the scope of the invention, which is to be given the full breadth of the appended claims and any and all equivalents thereof. Although specific terms are employed herein, they are used in a generic and descriptive sense only and not for purposes of limitation. Unless otherwise expressly defined herein, such terms are intended to be given their broad, ordinary, and customary meaning not inconsistent with that applicable in the relevant industry and without restriction to any specific embodiment hereinafter described. As used herein, the article “a” is intended to include one or more items. When used herein to join a list of items, the term “or” denotes at least one of the items, but does not exclude a plurality of items of the list. For exemplary methods or processes, the sequence and/or arrangement of steps described herein are illustrative and not restrictive.

It should be understood that the steps of any such processes or methods are not limited to being carried out in any particular sequence, arrangement, or with any particular graphics or interface. Indeed, the steps of the disclosed processes or methods generally may be carried out in various sequences and arrangements while still falling within the scope of the present invention.

The term “coupled” may mean that two or more elements are in direct physical contact. However, “coupled” may also mean that two or more elements are not in direct contact with each other, but yet still cooperate or interact with each other.

The terms “comprising,” “including,” “having,” and the like, as used with respect to embodiments, are synonymous, and are generally intended as “open” terms (e.g., the term “including” should be interpreted as “including, but not limited to,” the term “having” should be interpreted as “having at least,” the term “includes” should be interpreted as “includes, but is not limited to,” etc.).

As previously discussed, there is a need for an apparatus capable of providing proximity detection in a manner that is discreet, intuitive, and does not require continuous physical motion, service animals, or overt external signaling. It would further be advantageous if such an apparatus could be worn comfortably as part of normal attire, provide real-time feedback regarding the presence and proximity of objects, and operate effectively across a range of environments. The proximity detection apparatus disclosed herein solves these and other problems.

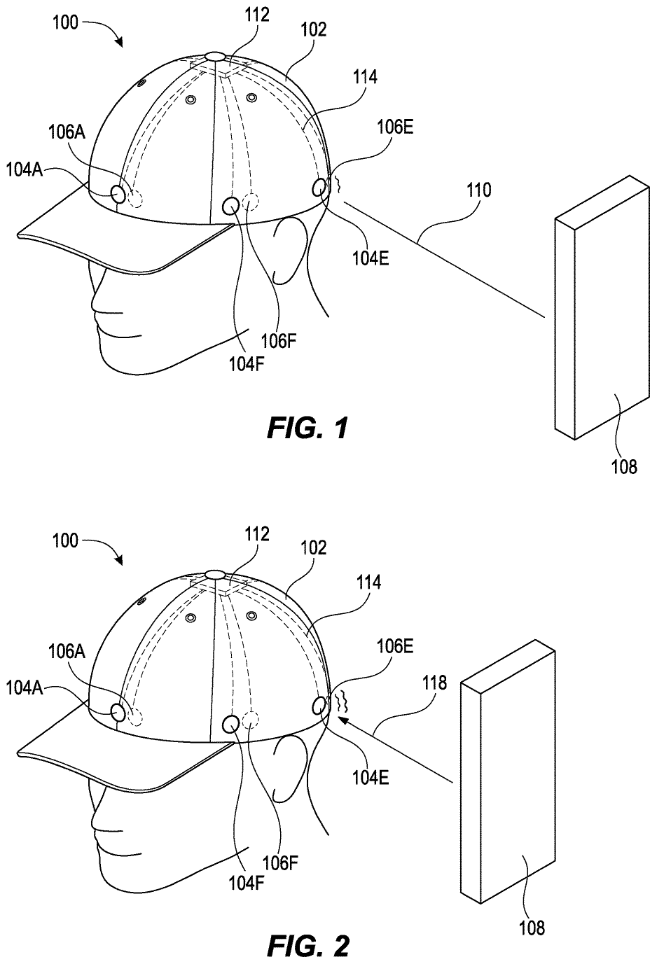

Generally speaking, in some embodiments, a proximity detection apparatus may comprise an article of clothing comprising one or more proximity sensors and one or more user indicators. Referring to FIGS. 1-6, in some embodiments, a proximity detection apparatus 100 comprises an article of clothing 102 (e.g., hat), at least one proximity sensor 104A-F (e.g., infrared sensors) coupled to, or embedded in, the article of clothing 102, and one or more user indicators 106A-F. As shown in FIG. 1, once the detected object 108 is within a first distance 110, an indicator 106E that is proximal to the proximity sensor 104E that detected the object 108, is actuated. In this example, the user indicator 106E may be a vibration motor (i.e., motor configured to provide vibratory feedback sensed by a user) configured to vibrate at a first intensity, indicating to the user that an object 108 (any obstacle or person) has been detected, but is at a safe distance.

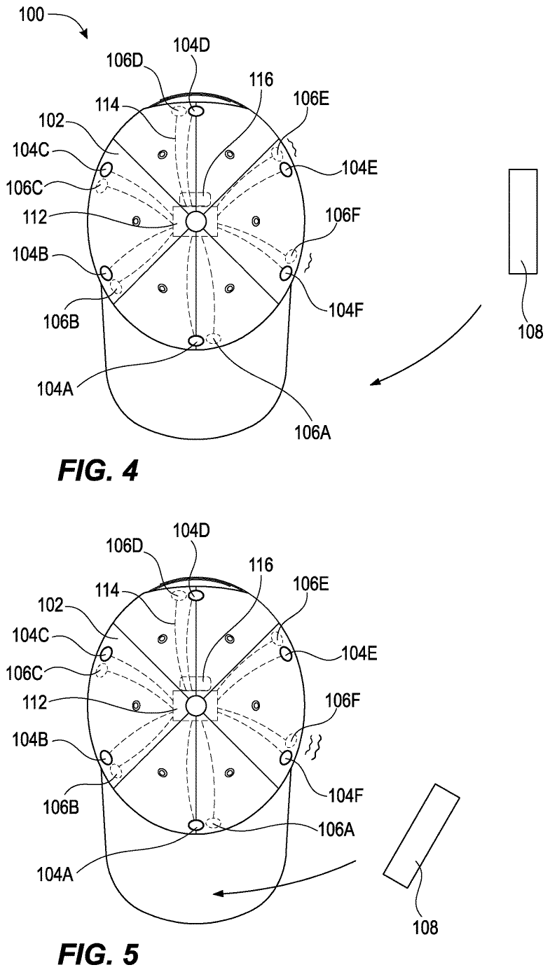

Each proximity sensor 104A-F is coupled to a processor 112 (e.g., microcontroller) that is configured to process the signals received from the proximity sensors 104A-F. Further, the processor 112 may be programmed or otherwise configured to control the user indicators 106A-F (e.g., motors) based upon the processed signals of the proximity sensors 104A-F. While one processor 112 is shown, it will be appreciated that more than one may be used without departing herefrom. As understood, proximity sensors 104A-F may be positioned so as to be externally exposed (i.e., not covered by fabric) so as to remain unobstructed for object detection. However, the user indicators 106A-F, processor 112, wiring 114, and battery 116 (FIG. 4) may all be hidden from view, such as on an internal surface of the article of clothing 102 (e.g., hat) or concealed between fabric layers of the article of clothing 102.

Referring to FIG. 2, as the detected object 108 moves closer to the user and is within a second distance 118, which is closer than the first distance 110, the user indicator 106E is configured to vibrate at a second intensity, greater than the first intensity, indicating to the user that the object 108 is now closer than the first distance 110.

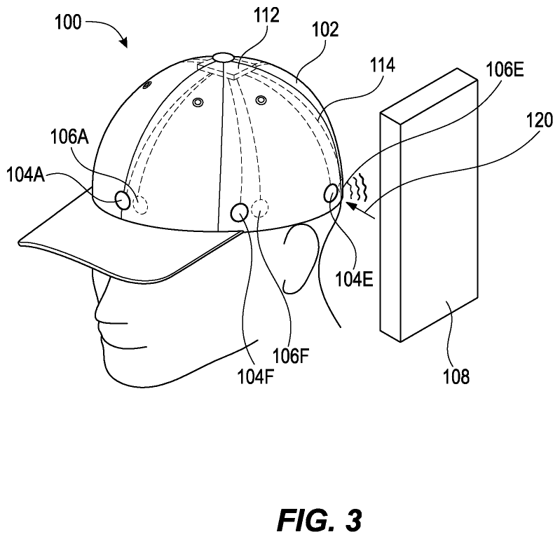

Referring to FIG. 3, as the detected object 108 moves even closer to the user and is within a third, closest distance 120, which is closer than the second distance 118, the user indicator 106E is configured to vibrate at a third intensity, greater than the second intensity, indicating to the user that the object 108 is now closer than the second distance 118, which may mean that contact is imminent if the user or the object 108 continue to approximate one another. This indicates to the user that they should move with caution to avoid a collision with the object 108 (which may be a wall, door, person, light post, etc.).

Referring now to FIGS. 4-6, as the object 108 and article of clothing 102 worn by a user move in relation to one another, the various proximity sensors 104A-F detect the movement, with the processor 112 configured to actuate corresponding motors or other user indicators 106A-F, thereby providing a reference to the user as to the location and approximate distance of the object 108 in relation to the user.

Specifically, referencing FIG. 4, the object 108 may be positioned on a left side of a user, wherein it is detected by two proximity sensors 104E, 104F positioned on the left of a user. Because both proximity sensors 104E, 104F detect the object 108, the processor 112 activates corresponding user indicators 106E, 106F (e.g., causes the motors to vibrate at a specific intensity, depending on the detected distance from the user), indicating to a user that the object 108 is directly on their left side and, given the strength of the signal, an indication as to distance.

Referring to FIG. 5, as the position of the object 108 moves in relation to the user, such as forwardly and closer, the user is notified accordingly. In other words, the rearward proximity sensor 104E no longer detects the object 108, and only the front, left proximity sensor 104F (temporal lobe position, for example) detects the object 108. As a result, only the user indicator 106F is actuated by the processor. This indicates to a user that the object 108 has moved in relation to their position, giving the user a clear indication of where the object 108 now resides. Further, as shown in FIG. 5, the intensity (e.g., vibration) of the user indicator 106F has increased, indicating to the user that the object 108 is now closer than previously. This may be the result of the object 108 moving in relation to the user, or in response to the user moving in relation to the object 108.

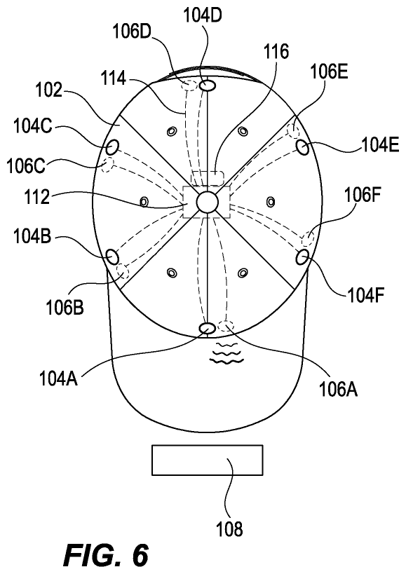

Referring to FIG. 6, the object 108 is now positioned directly in front of the user. Accordingly, only the front proximity sensor 104A detects the object 108, and as a result, the processor 112 actuates only the front user indicator 106A. As shown, because the object 108 is proximal and about to collide with the user, the front user indicator 106A is actuated at a third intensity (three squiggly lines indicative of vibration intensity), greater than the first two intensities in relation to FIGS. 4-5. As a result, the user knows that the object 108 is directly in front and very close in proximity, indicating the user to proceed with caution to avoid a collision with the object 108.

As noted earlier, despite being referred to as an “object” herein, it will be understood that the object may be a person, a wall, a vehicle, or anything that may come into close contact with the user. Further, although the article of clothing 102 is illustrated as a baseball hat, it will be appreciated that other headwear may be used without departing herefrom. Further, in some embodiments, the article of clothing 102 need not be head mounted, and may be located elsewhere on a user, such as at a waistline (via pants or belt having an integrated proximity detection system integrated therewith) or other convenient position for the wearer that is still capable of indicating relative positioning in relation to an object.

Additionally, while the proximity sensors 104A-F and user indicators 106A-F are shown as separate devices, it will be appreciated that they may be combined, such as on a single PCB or similar. Further, the proximity sensors 104A-F and/or user indicators 106A-F may be independently positioned in an article of clothing 102, or may be coupled to a band or other wearable object not requiring an article of clothing. In other words, the proximity detection apparatus may be an accessory itself that may be worn by a user without being embedded or otherwise coupled to a user. Such an accessory, such as a band, may be made from plastics, rubbers, elastics, or similar materials. Additionally, it will be appreciated that any suitable proximity sensor known in the art may be used, such as infrared sensors, ultrasonic sensors, laser sensors, etc.

By utilizing the proximity detection apparatus 100, a visually impaired user is able to discreetly determine their relative distance and position in relation to their surroundings, allowing them to maneuver accordingly, overcoming the limitations of the prior art.

While vibration motors have been shown and described as user indicators 106A-F, it will be appreciated that other user indicators may be used, alone or in combination with the vibration motors, without departing herefrom. For example, in some embodiments, a plurality of LEDs may be positioned on an underside of a hat brim, allowing users capable of seeing the lights produced the ability to know relative distance using varying colors, brightness, or other indicators.

In some embodiments, the user indicators 106A-F may comprise one or more speakers, and be configured with a wireless transceiver to transmit audio to a wireless earbud or hearing aid. This may provide audible information to a user as well, such as what the object is (e.g., person, wall, etc.) and the general direction of the object (e.g., a person one yard away at your two o'clock).

In some embodiments, the proximity sensors comprise infrared time-of-flight (ToF) distance sensors configured to emit eye-safe infrared radiation and to calculate distance based on a measured return time of reflected light. One example of a suitable ToF sensor includes the VL53L1X V2 sensor, which provides medium-range distance detection with a wide detection cone and high accuracy while maintaining low power consumption suitable for wearable use. The ToF-based sensors operate independently of ambient lighting conditions and are capable of reliably detecting solid obstacles, including walls, signs, poles, and people, within a sensing range of up to several meters.

Other sensors, such as ultrasonic sensors, LiDAR range finders, and ambient light or gesture sensors, may be used without departing herefrom. However, each of those may have drawbacks not experienced with the infrared sensors. For example, ultrasonic sensors were found to exhibit reduced accuracy and responsiveness in wearable head-mounted configurations, while LiDAR systems proved impractical due to size, power consumption, and cost. Ambient light and gesture sensors demonstrated insufficient reliability for obstacle detection in varying lighting environments. Accordingly, Infrared ToF sensors may provide a preferred balance of accuracy, size, power efficiency, and real-world usability for the disclosed apparatus.

In further embodiments, the processor is configured to generate a haptic gradient by selectively actuating multiple vibration motors positioned around the wearable article. The haptic gradient encodes both distance and direction of a detected object by varying vibration intensity, duty cycle, or frequency across spatially distributed user indicators. As an object approaches the user, vibration intensity increases, thereby providing intuitive, real-time feedback that allows the user to perceive proximity without reliance on visual or audible cues.

In some embodiments, one or more proximity sensors 104A-F are oriented upwardly or at elevated angles relative to the user in order to detect overhead obstacles, including signs, awnings, door frames, and other hazards located above ground level. Such elevated detection mitigates collision risks not addressed by traditional ground-level navigation aids. Likewise, one or more of the proximity sensors 104A-F may be oriented downwardly to aid in detecting objects in a walking path. In some embodiments, the processor 112 is further configured to perform automatic calibration routines and adaptive sensitivity adjustments. Calibration may occur upon device startup or dynamically during operation to account for environmental conditions, sensor drift, or user-specific preferences. The processor 112 may additionally filter static background objects from moving obstacles to reduce unnecessary feedback and to improve situational awareness for the user.

In some methods of use, a user would wear the proximity detection apparatus 100 to safely maneuver and navigate their surroundings. In other words, a user may wear the article of clothing 102 that comprises the proximity sensors 104A-F and user indicators 106A-F. The user indicators 106A-F may be programmed, via a microcontroller or other processor 112, to indicate depending on the distance detected by the proximity sensors 104A-F. For example, as a user approximates an object 108 (e.g., wall), at least one indicator 106A-F will be actuated and thereby indicate to a user that an object 108 is getting closer. In some embodiments, motors may vibrate with varying intensity and location, based upon the location and distance of the detected object 108. In the case of LEDs as user indicators, various colors may be used to indicate distances to a user, such as a green LED for a safe distance, a yellow LED for an intermediate distance, and a red LED for a very close distance. In the case of speakers, an audio signal is transmitted to one or more speakers. In the case of a wireless transceiver, audio signals are transmitted to wireless earphones or headphones. In each of these methods, it will be appreciated that complex software systems or user interfaces are not required. In other words, a user need not install application software on a personal device to interface with the proximity detection apparatus 100. Rather, a user may simply turn the power on/off to begin utilizing the device, making it easily usable by everyone.

Therefore, it will be appreciated from the foregoing that the proximity detection apparatus 100 disclosed herein solves the need for an apparatus that can provide proximity detection to a visually impaired user that does not require physical movement (e.g., swinging a cane), does not require service animals, and that is more discreet for the wearer, overcoming the limitations of the prior art.

It will be appreciated that systems and methods according to certain embodiments of the present disclosure may include, incorporate, or otherwise comprise properties or features (e.g., components, members, elements, parts, and/or portions) described in other embodiments. Accordingly, the various features of certain embodiments can be compatible with, combined with, included in, and/or incorporated into other embodiments of the present disclosure. Thus, disclosure of certain features relative to a specific embodiment of the present disclosure should not be construed as limiting application or inclusion of said features to the specific embodiment unless so stated. Rather, it will be appreciated that other embodiments can also include said features, members, elements, parts, and/or portions without necessarily departing from the scope of the present disclosure.

Moreover, unless a feature is described as requiring another feature in combination therewith, any feature herein may be combined with any other feature of a same or different embodiment disclosed herein. Furthermore, various well-known aspects of illustrative systems, methods, apparatus, and the like are not described herein in particular detail in order to avoid obscuring aspects of the example embodiments. Such aspects are, however, also contemplated herein.

Exemplary embodiments are described above. No element, act, or instruction used in this description should be construed as important, necessary, critical, or essential unless explicitly described as such. Although only a few of the exemplary embodiments have been described in detail herein, those skilled in the art will readily appreciate that many modifications are possible in these exemplary embodiments without materially departing from the novel teachings and advantages herein. Accordingly, all such modifications are intended to be included within the scope of this invention.

What is claimed is:

1. A wearable proximity detection apparatus, comprising:
an article wearable by a user;
a plurality of proximity sensors distributed about the article and configured to detect objects at varying distances and directions relative to the user;
a processor operatively coupled to the plurality of proximity sensors; and
a plurality of user indicators operatively coupled to the processor,
wherein the processor is configured to actuate at least one of the user indicators in response to detection of an object by at least one of the proximity sensors, and
wherein an intensity of actuation of the actuated user indicator varies based on a detected distance or direction of the object relative to the user.

2. The wearable proximity detection apparatus of claim 1, wherein the article comprises a hat.

3. The wearable proximity detection apparatus of claim 1, wherein the proximity sensors comprise infrared time-of-flight sensors.

4. The wearable proximity detection apparatus of claim 1, wherein the user indicators comprise vibration motors arranged to correspond spatially to respective proximity sensors.

5. The wearable proximity detection apparatus of claim 1, wherein the processor is configured to generate a haptic gradient indicating object distance and direction.

6. The wearable proximity detection apparatus of claim 1, further comprising a battery concealed within the article.

7. The wearable proximity detection apparatus of claim 1, wherein at least one of the plurality of proximity sensors is positioned to detect obstacles located above head level.

8. The wearable proximity detection apparatus of claim 1, wherein the plurality of user indicators are positioned on an interior surface of the article such that the plurality of user indicators are concealed from external view.

9. The wearable proximity detection apparatus of claim 1, wherein the processor is configured to actuate more than one user indicator simultaneously when the object is detected by more than one of the plurality of proximity sensors.

10. The wearable proximity detection apparatus of claim 1, wherein a direction of the object relative to the user is indicated by a spatial location of an activated user indicator of the plurality of user indicators on the article.

11. A wearable proximity detection apparatus, comprising:
a plurality of proximity sensors oriented in different directions around a user;
a processor configured to receive and process distance data from the plurality of proximity sensors; and
a plurality of motors configured to provide vibratory feedback to the user;
wherein the processor is further configured to control the vibratory feedback of the plurality of motors based on the processed distance data from the plurality of proximity sensors.

12. The wearable proximity detection apparatus of claim 11, wherein an intensity of the vibratory feedback increases as an obstacle distance decreases.

13. The wearable proximity detection apparatus of claim 11, wherein the plurality of proximity sensors and the plurality of motors are coupled to a headwear.

14. The wearable proximity detection apparatus of claim 11, wherein the proximity sensors comprise infrared time-of-flight sensors.

15. The wearable proximity detection apparatus of claim 11, further comprising a battery electrically coupled to the plurality of proximity sensors, the plurality of motors, and the processor.

16. A method of using a wearable proximity detection apparatus to assist a visually impaired user, the method comprising:
wearing the proximity detection apparatus including multiple proximity sensors and multiple user indicators;
detecting an object at a distance using at least one of the proximity sensors;
processing distance and directional information associated with the detected object; and
actuating at least one of the user indicators with a characteristic corresponding to the distance or direction of the detected object relative to the visually impaired user.

17. The method of claim 16, wherein actuating at least one of the user indicators comprises vibrating at least one motor.

18. The method of claim 17, further comprising vibrating the at least one motor with increasing intensity as a distance decreases between the user and the detected object.

19. The method of claim 16, further comprising dynamically adjusting sensitivity based on environmental conditions.

20. The method of claim 16, further comprising detecting overhead obstacles.
